(19) United States
(12) Patent Application Publication
(10) Pub. No.: US 2023/0157292 A1
(43) Pub. Date: May 25, 2023

(54) SEED COATING FORMULA FOR CONTROLLING SOYBEAN SOUTHERN BLIGHT AND SOYBEAN SHEATH BLIGHT

(71) Applicant: Institute of Plant Protection and Agro-products Safety, Anhui Academy of Agricultural Sciences, Hefei (CN)

(72) Inventors: Wei ZHAO, Hefei (CN); Rende QI, Hefei (CN); Shun CAO, Hefei (CN); Yuankai CHI, Hefei (CN); Amei XU, Hefei (CN); Tao WANG, Hefei (CN); Yue MA, Hefei (CN)

(73) Assignee: Institute of Plant Protection and Agro-products Safety, Anhui Academy of Agricultural Sciences, Hefei (CN)

(21) Appl. No.: 18/095,023

(22) Filed: Jan. 10, 2023

(30) Foreign Application Priority Data
Jan. 19, 2022 (CN) 202210060593.5

(51) Int. Cl. A01N 43/78; A01N 43/653

(52) U.S. Cl. CPC A01N 43/78; A01N 43/653

(57) ABSTRACT

The present invention discloses a seed coating formula for efficiently controlling soybean southern blight and soybean sheath blight. A fungicide is composed of Thifluzamide and Ipconazole; an appropriate amount of agricultural fungicide adjuvant is added to the fungicide; and a suspended seed coating and a microcapsule suspended seed coating used by the seed coating are prepared. The present invention has a better control effect on fungal diseases of crops, achieves an obvious synergism between two agents, has an effect of broadening a disease-resistant spectrum, realizes comprehensive control of multiple diseases, significantly decreases a pesticide application rate, effectively decreases ecological damage and environmental pollution, and improves yield and quality of the crops. In the present invention, the Thifluzamide and the Ipconazole have low toxicity and are safe to people and livestock, beneficial organisms and the environment; and drug resistance of pathogenic bacteria to a single agent may be delayed.

### CROSS REFERENCE TO RELATED APPLICATION

This patent application claims the benefit and priority of Chinese Patent Application No.202210060593.5 filed on Jan. 19, 2022, the disclosure of which is incorporated by reference herein in its entirety as part of the present application.

### TECHNICAL FIELD

The present invention belongs to the field of agricultural fungicides, and particularly relates to a fungicidal composition of Thifluzamide and Ipconazole. A suspended seed coating or a microcapsule suspended seed coating is prepared by adding an appropriate amount of adjuvant, and then is used for seed coating for effectively controlling soybean southern blight and soybean sheath blight and further controlling rhizome base diseases such as Fusarium root rot of soybeans, soybean stem blight, soybean red charcoal rot and soybean charcoal rot.

### BACKGROUND

Soybeans and bean products are one of the major sources of traditional edible vegetable oil and proteins in China. With the development of the national economy and the improvement of living standards of residents, demands for soybeans have been higher and higher, particularly the pursuit of broad masses on health; and the quantities of directly-edible bean products and vegetable oil have been rapidly increased. Based on the demands and strategic security considerations of domestic soybeans, the report of National Cropping Structure Adjustment Planning (2016-2020) issued by Ministry of Agriculture and Rural Affairs, PRC in 2016 stated that, soybean supply should be increased; quality should be improved; benefits should be increased; crop rotation of grains and soybeans should be conducted by adjusting measures to local conditions; crop rotation of corn and soybean, double cropping a year for wheat and soybean or intercropping of the corn and soybean are promoted in Huang-Huai-Hai region; and the soybean planting area should be appropriately restored, so that the soybean area is up to 140 million mu in China and is increased by about 40 million mu.

However, in recent years, along with the change of farming modes, the traditional straw burning has been strictly prohibited, so that pathogens in soil are accumulated, and the risk of disease outbreak is increased. Meanwhile, due to global warming and other changes of natural environmental conditions, the damaging range of some regional diseases and sporadic diseases is expanding, while with human requirements on high quality of grain crops, high-quality varieties easily cause outbreak and spread of novel diseases. In the novel diseases, sheath blight caused by Rhizoctonia solani and southern blight caused by Sclerotium rolfsii are common diseases of main crops. Serious diseases may be caused on main vegetables and soybeans; the damage is particularly serious at a seedling stage of the crops; uneven seedlings and ridge breaking are caused; and crop yield is affected. The sheath blight is mainly infected before seed emergence, and then the seedlings die without lodging. Therefore, the diseases should be controlled at sowing time. The southern blight may be infected at different stages of plants, has the most serious infection at the seedling stage, and may damage roots, stems, leaves and fruits of the plants. The damage degrees of sheath blight or sudden death of the soybeans caused by the Sclerotium rolfsii and Rhizoctonia solani are increasing year by year; and the occurrence area is gradually enlarged. In addition, root and stem base diseases such as Fusarium root rot caused by different species of Fusarium spp, soybean stem blight caused by Diaporthe spp, red charcoal rot caused by Calonectria ilicicola and charcoal rot caused by Macrophomina phaseolina have severely threatened the development of soybean industry. At present, the diseases caused by the above pathogens are mainly controlled chemically. However, due to long-term use of a single agent and unreasonable application modes, the pathogens easily produce drug resistance. Thus, the drug efficacy is decreased and the outbreak of the diseases is caused. Then, medication is increased, thereby forming a vicious circle, increasing the medication cost and worsening environmental pollution. This is also a major problem of chemical control. Reasonable compounding of pesticides having different chemical structures and different action mechanisms is an effective measure to overcome occurrence and development of the drug resistance, and may improve the performance, decrease the medication amount in unit area and improve control effects.

Thifluzamide is a new thiazole carboxyl-N-benzamide fungicide, and has a chemical name of 2′,6′-dibromo-2-methyl-4′-trifluoromethoxy-4-trifluoromethyl-1,3-thiadiazole-5-hydroxyanilide. An active compound of the Thifluzamide is white to light brown solid powder, has a melting point of 177.9-178.6° C., water solubility of 1.6 mg/L at 20° C. and a distribution coefficient of 4.1, and is stable at a pH value of 5-9. The Thifluzamide is a low-toxicity fungicide, and has no teratogenetic, mutagenic or carcinogenic effect at rat acute oral and rabbit acute dermal LD₅₀>5000 mg/kg and acute dermal LD₅₀>2000 mg/kg. The fungicide is a succinic dehydrogenase inhibitor (SDHI), mainly acts on a respiratory chain electron transport complex II for blocking energy metabolism, and has protection, treatment, intake and transportation effects. The treated seeds may absorb the Thifluzamide in the germination process and transport the Thifluzamide to other parts of the plant body through xylem, thereby achieving an effect of protecting the crops.

Ipconazole is a triazole fungicide developed by Kureha Company of Japan in the early 1990s, has a Chinese chemical name of (1RS, 2SR, 5RS; 1RS, 2SR, 5 SR)-2-(4-chlorobenzyl)-5-isopropyl-1-(1H-1,2,4-triazole-1-ylmethyl) cyclopentanol, and has a molecular formula of C₁₈H₂₄ClN₃O. The Ipconazole is a broad-spectrum systematic fungicide and mainly affects the formation of fungal cell walls by inhibiting biosynthesis of fungal ergosterol, thereby achieving the purpose of inhibiting fungal growth. The Ipconazole has excellent intake transportation and contact protection activities, has the characteristics of being low in application dose, high in activity and safe to monocotyledon and dicotyledon crops, and has intake, protection and treatment effects. The Ipconazole, which mainly serves as a seed treatment agent, is higher in activity, relatively safe and usually used for controlling seed diseases of rice and other crops, and has an excellent effect of controlling rice bakanae disease, Helminthosporium leaf spot and rice blast. As the seed treatment agent, the Ipconazole is widely used.

### SUMMARY

The present invention provides a composition having an obvious synergism of controlling soybean sheath blight and soybean southern blight. The composition increases a disease-resistant spectrum while increasing the control effect, may further control major root and stem base diseases of soybeans, such as Fusarium root rot of soybeans, soybean stem blight, soybean red charcoal rot and soybean charcoal rot, and provides an efficient formula composition for comprehensive control of the soybean diseases.

Technical solutions of the present invention are as follows:

A seed coating formula for controlling soybean sheath blight and soybean southern blight is provided, wherein the fungicide is composed of Thifluzamide and Ipconazole.

The fungicide is characterized in that a mass ratio of the Thifluzamide to the Ipconazole is 20:1 to 1:20. When the fungicide is used for controlling the soybean southern blight, the mass ratio of the Thifluzamide to the Ipconazole is 1:1 to 1:10; and when the fungicide is used for controlling the soybean sheath blight, the mass ratio of the Thifluzamide to the Ipconazole is 5:1 to 1:5.

The above composition is further added with an appropriate amount of auxiliary materials through a certain proportion, such as a dispersing agent, an anti-freezing agent, a film-forming agent, a thickening agent, and a suspended seed coating or a microcapsule suspended seed coating prepared by warning coloration. Through the certain proportion, the seed coating effectively increases the germination rate of soybean seeds, efficiently controls the soybean southern blight and the soybean sheath blight, and further controls the major root and stem base diseases of soybeans, such as Fusarium root rot of soybeans, soybean stem blight, soybean red charcoal rot and soybean charcoal rot.

Significant effects and advantages of the present invention are as follows:

Two categories of fungicides having different structure types and different action mechanisms are added with efficient adjuvants and processed into a suspended seed coating or a microcapsule suspended seed coating that is easily used in production. The seed coating is high in biological activity, increases the germination rate and survival rate of the seeds, increases disease resistance of plants, increases the disease-resistant spectrum, and has an excellent effect of controlling frequent seedling diseases in production. Moreover, the total dose is decreased in unit area after complex synergism; medication frequency is decreased; administration cost is lowered; occurrence and development of drug resistance of pathogens are delayed; the service life of various components in the fungicidal composition is prolonged; and the seed coating is good in crop safety, thereby achieving the invention purposes of economy, high efficiency and environmental protection.

The present invention further provides an application of the fungicidal composition in control of fungal diseases of crops.

### DETAILED DESCRIPTION OF THE EMBODIMENTS

Fungicidal properties of Thifluzamide and Ipconazole were analyzed in detail. EC₅₀ (drug safety index) of two single compounds (hereinafter referred to as agents), such as Thifluzamide and Ipconazole, was respectively determined; a combined proportion of the two agents was set by a Wadley method according to the EC₅₀ of the two single agents; and a synergism ratio (SR) was calculated according to the Wadley.

Test targets were Rhizoctonia solani and Sclerotium rolfsii, but not limited herein. The Thifluzamide and Ipconazole were prepared into a liquid medicine plate in a PDA solid medium; and a volume of each dish was about 18 ml. Hypha blocks having a diameter of 5 mm were made on the edges of pre-culture colonies by a sterilized puncher and respectively transferred onto different medium plates for culturing at 25° C. A hypha growth measurement method was adopted in the test to prepare drug-containing media according to different treatments; the hypha blocks having the diameter of 5 mm were made on the edges of pre-culture colonies by the sterilized puncher and respectively transferred onto medium plates having different drug contents; a colony diameter was measured by a crossing method; the colony diameter (mm) was measured; and a growth inhibition ratio was calculated by the following formulas:

Hypha growth inhibition ratio %=(1−agent treatment colony diameter−5/control colony diameter−5)×100%

The hypha growth inhibition ratio was converted into an inhibition probability value (y); the agent concentration was converted into a concentration logarithm (x); a toxic regression line was drawn by taking the concentration logarithm as a horizontal coordinate and taking the probability value as a vertical coordinate; a toxic regression equation of the single agents such as the Thfiluzamide and Ipconazole and a mixture thereof for pathogenic bacteria was solved; and the EC₅₀ value and a related ratio r were calculated.

Interaction of the mixture was evaluated according to the Wadley method; and calculation formulas were as follows:

EC₅₀(theoretical value)=(a+b)/(a/EC₅₀a+b/EC₅₀b)

SR=EC₅₀(theoretical value)/EC₅₀(actual value).

In the formulas, a and b were content ratios of the various components in the mixture; and a mixing effect was analyzed by the SR value. When SR≤0.5, the mixture of the two agents had antagonism; when SR=0.5-1.5, the mixture of the two agents had an addition effect; and when SR≥1.5, the mixture of the two agents had synergism.

TABLE 1
Toxicity determination results of the single agents of Thifluzamide and Ipconazole
and the mixture thereof for Sclerotium rolfsii

| | | | | EC₅₀ | |
|---|---|---|---|---|---|
| Proportion | Regression | Related ratio | | (theoretical) | |
| (T:I) | equation | (r) | EC₅₀ ppm | ppm | SR |
| Thifluzamide | y = 6.0108 + 1.1228x | 0.9712 | 0.1258 | | |
| (T) | | | | | |
| Ipconazole (I) | y = 6.8995 + 1.279x | 0.998 | 0.0327 | | |
| 5:1 | y = 6.4882 + 1.2443x | 0.9974 | 0.0637 | 0.0854 | 1.3404 |
| 1:1 | y = 6.8869 + 1.2533x | 0.9958 | 0.0312 | 0.0519 | 1.6635 |
| 1:5 | y = 7.3455 + 1.4071x | 0.9973 | 0.0215 | 0.0373 | 1.7335 |
| 1:10 | y = 7.1987 + 1.32x | 0.9912 | 0.0216 | 0.0351 | 1.6247 |
| 1:15 | y = 7.0734 + 1.278x | 0.9978 | 0.0239 | 0.0343 | 1.4381 |

It can be seen from the above table that, the composition of the Thfiluzamide and Ipconazole of different ratios has different antibacterial effects on the Sclerotium rolfsii; and in general, the composition has synergism in a ratio range of 1:1-1:10.

TABLE 2
Toxicity determination results of the single agents of Thifluzamide and Ipconazole
and the mixture thereof for Rhizoctonia solani

| | | | | EC₅₀ | |
|---|---|---|---|---|---|
| Proportion | Regression | Related ratio | | (theoretical) | |
| (T:I) | equation | (r) | EC₅₀ ppm | ppm | SR |
| Thifluzamide | y = 5.8547 + 1.0518x | 0.983 | 0.154 | | |
| (T) | | | | | |
| Ipconazole (I) | y = 7.0475 + 1.2308x | 0.9835 | 0.0217 | | |
| 10:1 | y = 6.1409 + 1.1426x | 0.9989 | 0.1003 | 0.0991 | 0.9873 |
| 5:1 | y = 6.7949 + 1.3472x | 0.9963 | 0.0465 | 0.0764 | 1.6416 |
| 1:1 | y = 6.9833 + 1.2335x | 0.9802 | 0.0247 | 0.038 | 1.5401 |
| 1:5 | y = 7.0581 + 1.1451x | 0.9725 | 0.0159 | 0.0253 | 1.5881 |
| 1:10 | y = 7.0803 + 1.1657x | 0.9685 | 0.0164 | 0.0235 | 1.4334 |

It can be seen from the above table that, the composition of the Thifluzamide and Ipconazole of different ratios has different antibacterial effects on the Rhizoctonia solani; and in general, the composition has synergism in a ratio range of 5:1-1:5.

Determination results of indoor combined action show that, the composition of the Thifluzamide and Ipconazole has an excellent growth inhibition effect on the Rhizoctonia solani and the Sclerotium rolfsii, and has an excellent effect of controlling frequent root and stem base diseases at a seedling stage in production, such as Fusarium root rot of soybeans, soybean stem blight, soybean red charcoal rot and soybean charcoal rot; and an obvious synergism exists between the two components. The compound of the two components according to a certain ratio may decrease the dose, increase the disease-resistant spectrum, effectively decrease ecological damage and environmental pollution, and can improve the yield and the quality of the crops. In the present invention, both the Thifluzamide and Ipconazole have low toxicity and are safe to people and livestock, beneficial organisms and the environment; and drug resistance of pathogenic bacteria to the single agent may be delayed.

The present invention will be further described below in combination with embodiments. However, the essence of the present invention is not limited to the embodiments below.

### Embodiment 1

Preparation of 10% Thifluzamide* Ipconazole Suspended Seed Coating, in Percentage by Mass.

5% of Thyluzamide, 5% of Ipconazole, 2.2% of xanthan gum, 6% of a dispersing agent FS3000, 5% of calcium lignosulfonate, 3% of ethylene glycol, 0.3% of aluminum-magnesium silicate, 0.5% of bentonite, 1.5% of dioctylsulfosuccinate sodium, 2% of an organic silicon defoamer, 5% of a film-forming agent, 2% of a dye and the balance of water.

Preparation method: according to a formula, the above components (except for the film-forming agent and the dye) were weighed according to a ratio; the weighed components were added into a ball mill for ball-milling for 60 min; the milled components were filtered; the components were extracted into a dispersing tank for shearing at high speed for 3 min and then fully ground by a sand mill; a diameter of solid component particles was controlled within 1 μm; the components were uniformly stirred after grinding; and the film-forming agent and the dye were added into the mixture to obtain the suspended seed coating product.

### Embodiment 2

Preparation of 12% Thifluzamide Ipconazole Microcapsule Suspended Seed Coating, in Percentage by Mass.

2% of Thifluzamide, 10% of Ipconazole, 8% of methyl oleate, 4% of cyclohexanone, 3% of methylenediphenyl diisocyanate, 2% of fatty acid amide N-methyl taurate, 0.5% of ethanediamine, 1.2% of 1,3-propanediol, 2% of sodium methylene bis-naphthalene sulfonate, 3.2% of aluminum-magnesium silicate, 2% of acacia gum, 2% of polyvinyl alcohol, 2.5% of polyacrylate, 4% of permanent red and the balance of water.

Preparation method: the Thifluzamide and the Ipconazole were dissolved into a solvent according to a ratio; the methylenediphenyl diisocyanate was added into the components and uniformly stirred to obtain an oil phase; an emulsifier and an adjuvant were added into water and uniformly stirred to obtain a water phase; the water phase was added into the oil phase for high-speed homogenization to obtain oil-in-water emulsion; ethanediamine was added to participate in interfacial polymerization under a speed condition of 450 rpm; reaction temperature was increased to 55° C. and maintained for 3 h; the components were cured into capsules; and the sodium methylene bis-naphthalene sulfonate, aluminum-magnesium silicate, permanent red, polyvinyl alcohol and polyacrylate were added and uniformly stirred, thereby preparing the microcapsule suspended seed coating.

Field control experiment of the seed coating.

Field tests were respectively conducted in Yongqiao District, Suzhou in 2020 and 2021. The test place was located in a test base of Suzhou Academy of Agricultural Sciences. Test data of 2021 were collected as follows; the experimental soybean variety was “Wandou 37”; and the seed coating used in the experiment was subjected to soybean seed coating treatment according to a ratio. The coated soybean seeds were naturally dried in the shade and sowed; an emergence rate, plant heights, root lengths, fresh weight and a control effect were investigated within 20 days after sowing; and the control effect was investigated within 40 days after sowing. Finally, the yield was investigated.

TABLE 3
Comprehensive control effects of different seed coating formulas on soybean growth and soybean root and stem base diseases

| | | | | | | | Control | |
|---|---|---|---|---|---|---|---|---|
| | Liquid | Within 20 days after sowing | | | | | effect (%) | |
| | medicine | | Plant | Root | Fresh | Control | within | |
| | (g):seeds | Emergence | height | length | weight | effect | 40 days | Yield (Kg |
| Treatment agent | (g) | rate (%) | (cm) | (cm) | (g) | (%) | after sowing | per mu) |
| 10% | 1:2000 | 92.5 | 18.4 ± 1.6 | 15.9 ± 2.1 | 3.19 ± 0.18 | 95.5 | 80.6 | 182.8 ± 10.5 |
| Thifluzamide•Ipconazole | 1:4000 | 91.6 | 17.9 ± 1.2 | 16.8 ± 2.4 | 3.3 ± 0.17 | 94.3 | 79.8 | 178.8 ± 6.6 |
| suspended seed coating | | | | | | | | |
| 12% | 1:2000 | 93.7 | 19.2 ± 1.3 | 16.5 ± 1.8 | 3.25 ± 0.27 | 98.7 | 91.2 | 204.5 ± 8.4 |
| Thifluzamide•Ipconazole | 1:4000 | 90.5 | 19.6 ± 1.1 | 17.5 ± 2.2 | 2.95 ± 0.34 | 95.2 | 86.5 | 190.1 ± 7.3 |
| microcapsule suspended | | | | | | | | |
| seed coating | | | | | | | | |
| 5% | 1:1000 | 87.7 | 18.4 ± 1.5 | 15.8 ± 1.5 | 2.83 ± 0.15 | 79.7 | 56.7 | 146.1 ± 8.7 |
| Thifluzamide suspended | | | | | | | | |
| seed coating | | | | | | | | |
| 5% | 1:1000 | 85.2 | 17.2 ± 1.8 | 16.6 ± 2.3 | 2.62 ± 0.15 | 83.2 | 70.4 | 156.1 ± 4.3 |
| Ipconazole suspended | | | | | | | | |
| seed coating | | | | | | | | |
| Blank control | Clear | 76.5 | 15.8 ± 1.5 | 14.5 ± 1.9 | 2.23 ± 0.26 | — | — | 128.5 ± 4.8 |
| | water | | | | | | | |

Field test results show that, the suspended seed coating formed by the Thifluzamide and Ipconazole increases the emergence rate, the plant heights, the root lengths and the fresh weight of the soybeans, and has an obvious integrated control effect on the soybean root and stem diseases; and the control effect of the composition is significantly higher than the control effect of a single agent. The slow release function of the 12% Thifluzamide Ipconazole microcapsule suspended seed coating has a more significant control effect at a later stage. In the range of test doses, the crops grow normally; no plant has risk of damage or abnormal phenomenon; and the seed coating is safe to the soybeans. The yield of the soybeans treated by the seed coating is significantly higher than that of the blank control without using the seed coating; the yield of the composition formed by the Thifluzamide and Ipconazole is also significantly higher than the yield of a single agent; and the composition has excellent control effect and production increase effects while significantly decreasing the dose. The above results show that, the control effect of the suspended seed coating formed by the Thifluzamide and Ipconazole is significantly higher than that of the single agent; and the pesticide application rate is decreased, mainly because the synergism and the disease-resistant spectrum of the composition are increased. The major diseases of the soybeans at the seedling stage may be efficiently controlled in a broad-spectrum manner; and occurrence degrees of later diseases are decreased, to achieve the purposes of physical synergism and increase in yield and income.

Finally, it should be further noted that, the above listed contents are merely several specific embodiments of the present invention. Apparently, the present invention is not limited to the above embodiments and may have many transformations. In addition to the dosage form of the seed coating, dosage forms such as water suspension, wettable powder, microcapsules or water dispersible granules may be produced. All transformations that can be directly derived or thought from the contents disclosed in the present invention by those ordinary skilled in the art shall be considered as the protection scope of the present invention.

What is claimed is:

1. A seed coating formula containing Thifluzamide and Ipconazole, comprising active ingredients of Thifluzamide and Ipconazole, wherein a mass ratio of the Thifluzamide to the Ipconazole is 20:1-1:20.

2. The seed coating formula according to claim 1, wherein the mass ratio of the Thifluzamide to the Ipconazole is 10:1-1:10.

3. The seed coating formula according to claim 2, wherein the mass ratio of the Thifluzamide to the Ipconazole is 1:1-1:10 or 5:1-1:5.

4. The seed coating formula according to claim 1, further comprising agricultural auxiliary components which are prepared into a suspending agent, granules, wettable powder, water dispersible granules, a suspended seed coating or a microcapsule suspended seed coating.

5. The seed coating formula according to claim 5, wherein a weight percentage content of the active ingredients is 1-80%.

6. The seed coating formula according to claim 5, wherein auxiliary materials comprise one or more of a dispersing agent, an antifreezing agent, a film-forming agent, a thickening agent or a warning color; and the preparation is a suspended seed coating or a microcapsule suspended seed coating.

7. An application of the seed coating formula according to claim 1 in control of soybean southern blight and soybean sheath blight, wherein when the seed coating formula is used for controlling the soybean southern blight, a mass ratio of the Thifluzamide to the Ipconazole is 1:1-1:10;
and when the seed coating formula is used for controlling the soybean sheath blight, a mass ratio of the Thifluzamide to the Ipconazole is 5:1-1:5.

8. The application according to claim 7, wherein the seed coating formula further controls Fusarium root rot of soybeans, soybean stem blight, soybean red charcoal rot and soybean charcoal rot.
